(19) United States
(12) Patent Application Publication
(10) Pub. No.: US 2014/0176029 A1
(43) Pub. Date: Jun. 26, 2014

(54) VEHICLE AND CONTROL DEVICE FOR VEHICLE

(71) Applicants: Tetsuya NOMURA, Obu-shi (JP); Akiyoshi MORII, Obu-shi (JP); Makoto NAKAMURA, Okazaki-shi (JP); Mikio YAMAZAKI, Toyota-shi (JP)

(72) Inventors: Tetsuya NOMURA, Obu-shi (JP); Akiyoshi MORII, Obu-shi (JP); Makoto NAKAMURA, Okazaki-shi (JP); Mikio YAMAZAKI, Toyota-shi (JP)

(73) Assignees: DENSO CORPORATION, Kariya-shi (JP); TOYOTA JIDOSHA KABUSHIKI KAISHA, Toyota-shi (JP)

(21) Appl. No.: 14/136,325

(22) Filed: Dec. 20, 2013

(30) Foreign Application Priority Data
Dec. 25, 2012 (JP) 2012-280921

(51) Int. Cl. H02P 6/08

(52) U.S. Cl. CPC H02P 6/085
USPC 318/400.3

(57) ABSTRACT

On a vehicle, a converter converting and outputting a voltage, an inverter converting DC power output from the converter to AC power, and a motor driven by AC power supplied from the inverter are mounted. A control device for this vehicle controls the inverter in a control mode selected in accordance with a degree of modulation of the inverter, selects a target control mode of the inverter, and varies an output voltage from the converter such that a degree of modulation of the inverter varies until the control mode switches to the target control mode when a current control mode is different from the target control mode.

This nonprovisional application is based on Japanese Patent Application No. 2012-280921 filed on Dec. 25, 2012 with the Japan Patent Office, the entire contents of which are hereby incorporated by reference.

### BACKGROUND OF THE INVENTION

1. Field of the Invention

The present invention relates to a vehicle and a control device for a vehicle, and particularly to a technique for controlling an output voltage from a converter in a vehicle incorporating a motor driven by electric power supplied through a converter and an inverter.

2. Description of the Background Art

A hybrid car, a fuel cell car, and an electric car which incorporate an electric motor as a drive source have been known. For example, a three-phase AC motor is employed as the electric motor. Such an electric motor is supplied with AC power from an inverter.

Various techniques can be used for controlling an inverter. By way of example of a technique used for controlling an inverter, Japanese Patent Laying-Open No. 2006-311768 discloses control of an inverter with the use of a control scheme selected from among a sine wave PWM (Pulse Width Modulation) control scheme, an overmodulation PWM control scheme, and a rectangular wave control scheme. In Japanese Patent Laying-Open No. 2006-311768, by way of example, a control scheme is selected based on a degree of modulation of an inverter, as described in paragraph 66.

### SUMMARY OF INVENTION

In a case where a control scheme is selected in accordance with a degree of modulation of an inverter, for example, when a rotation speed or torque of an electric motor abruptly changes due to influence by disturbance and consequently amplitude of a drive voltage of the electric motor abruptly changes, a degree of modulation of the inverter also abruptly changes and the control scheme for the inverter may be changed. In this case, since the inverter is controlled with a control scheme different from a desired control scheme, it is desirable to quickly put the control scheme back to the original scheme.

In addition, a PWM control scheme suffers from loss involved with a switching operation of an inverter. Therefore, under such a condition that a rectangular wave control scheme can be selected, desirably, transition to the rectangular wave control scheme is quickly made.

The present invention was made in view of the problems described above, and an object thereof is to change a control scheme for an inverter.

As to one aspect of the present invention, a vehicle includes a converter converting and outputting a voltage, an inverter converting DC power output from the converter to AC power, a motor driven by AC power supplied from the inverter, and a control device configured to control the converter and inverter. The control device controls the inverter in a control mode selected in accordance with a degree of modulation of the inverter and selects a target control mode, and varies an output voltage from the converter such that a degree of modulation of the inverter varies until the control mode switches to the target control mode when a current control mode is different from the target control mode.

As to another aspect of the present invention, a vehicle incorporates a converter converting and outputting a voltage, an inverter converting DC power output from the converter to AC power, and a motor driven by AC power supplied from the inverter. A control device for this vehicle includes inverter control means for controlling the inverter in a control mode selected in accordance with a degree of modulation of the inverter, selection means for selecting a target control mode, and converter control means for varying an output voltage from the converter such that a degree of modulation of the inverter varies until the control mode switches to the target control mode when a current control mode is different from the target control mode.

According to the above configurations, when the current control mode is different from the target control mode, the degree of modulation of the inverter varies with variation in the output voltage from the converter, so that the control mode is switched. Therefore, a control scheme for the inverter can be changed to desired one.

The control mode may be switched when the degree of modulation of the inverter exceeds a prescribed threshold value. In this case, when the current control mode is different from the target control mode, a value greater than the threshold value may be set as a target degree of modulation and the output voltage from the converter may be lowered such that the degree of modulation of the inverter varies to the target degree of modulation.

In contrast, the control mode may be switched when the degree of modulation of the inverter is lower than a prescribed threshold value. In this case, when the current control mode is different from the target control mode, a value smaller than the threshold value may be set as a target degree of modulation and the output voltage from the converter may be raised such that the degree of modulation of the inverter varies to the target degree of modulation.

By using a degree of modulation which can be calculated from a ratio between an output voltage and an input voltage of an inverter, a converter can be controlled while a state of the inverter is specifically ascertained as a numeric value.

The target control mode may be selected in response to an operation of an accelerator by a driver. Thus, a control mode desired by the driver can be realized.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram of an overall configuration of a motor drive system.

FIG. 2 is a diagram illustrating a control scheme employed in the motor drive system.

FIG. 3 is a diagram showing an operation region in which each of sine wave PWM control, overmodulation PWM control, and rectangular wave control is employed.

FIG. 4 is a diagram showing a current vector of an AC electric motor.

FIG. 5 is a diagram illustrating switching of a control scheme.

FIGS. 6A to 6C are diagrams showing characteristics of loss in the overall motor drive system.

FIG. 7 is a control block diagrams in a sine wave PWM control scheme and an overmodulation PWM control scheme.

FIG. 8 is a flowchart showing processing performed for setting a target control mode (a requested control mode).

FIG. 9 is a flowchart showing processing performed for setting a target degree of modulation.

FIG. 10 is a diagram showing a target degree of modulation and a system voltage varied until a control mode switches from rectangular wave control to PWM control.

FIG. 11 is a control block diagram during the rectangular wave control scheme.

FIG. 12 is a control block diagram of a current phase feedback portion in FIG. 11.

FIG. 13 is a diagram showing a map used for calculation of a voltage difference ΔVH by the current phase feedback portion in FIG. 11.

### DESCRIPTION OF THE PREFERRED EMBODIMENTS

An embodiment of the present invention will be described hereinafter in detail with reference to the drawings. It is noted that the same or corresponding elements in the drawings below have the same reference characters allotted and description thereof will not be repeated in principle.

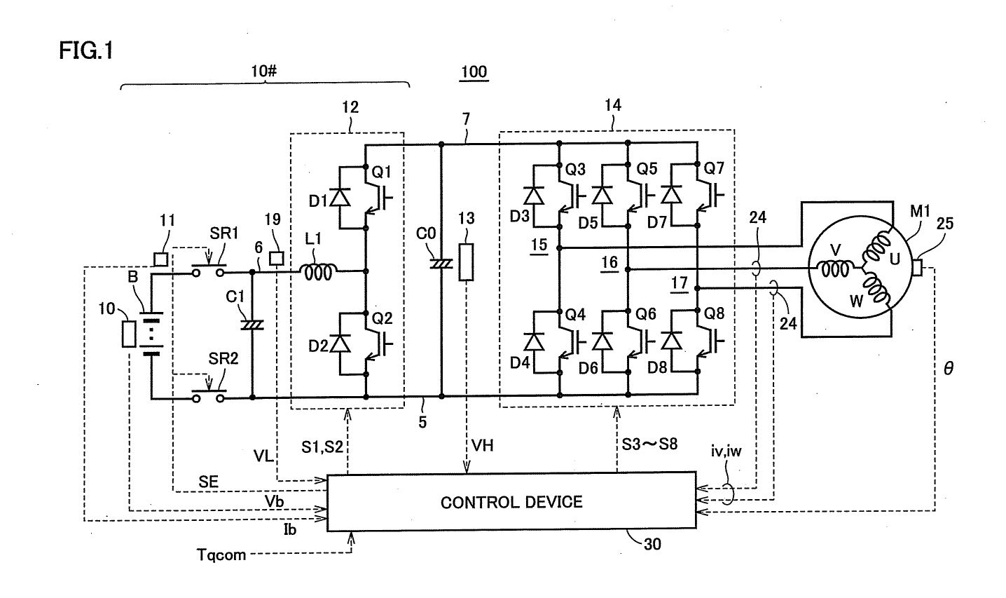

FIG. 1 is a diagram of an overall configuration of a control system 100 for an AC electric motor mounted as a drive source on a vehicle. Control system 100 includes a DC voltage generation portion 10#, a smoothing capacitor C0, an inverter 14, an AC electric motor M1, and a control device 30.

AC electric motor M1 is, for example, a traction motor configured to generate torque in a drive wheel of an electrically-powered vehicle (comprehensively expressing a car capable of generating vehicle driving force with electric energy, such as a hybrid car, an electric car, and a fuel cell car). Alternatively, this AC electric motor M1 may be configured to have a function as a generator driven by an engine and may be configured to function as both of an electric motor and a generator. Namely, in the present embodiment, the AC electric motor includes a motor generator. In addition, for example, AC electric motor M1 may be incorporated in a hybrid car as a component being able to start the engine.

DC voltage generation portion 10# includes a DC power supply B, system relays SR1, SR2, a smoothing capacitor C1, and a boost converter 12.

DC power supply B is implemented representatively by such a rechargeable power storage device as a secondary battery such as a nickel metal hydride battery or a lithium ion battery, and an electric double layer capacitor. A DC voltage Vb output from DC power supply B and an input and output DC current Ib are sensed by a voltage sensor 10 and a current sensor 11, respectively.

System relay SR1 is connected between a positive electrode terminal of DC power supply B and a power line 6, and system relay SR2 is connected between a negative electrode terminal of DC power supply B and a power line 5. System relay SR1, SR2 is turned on/off by a signal SE from control device 30.

Boost converter 12 includes a reactor L1, power semiconductor switching elements Q1, Q2, and diodes D1, D2. Power semiconductor switching elements Q1 and Q2 are connected in series between a power line 7 and power line 5. On and off of power semiconductor switching elements Q1 and Q2 is controlled by switching control signals S1 and S2 from control device 30.

In this embodiment of the invention, an IGBT (Insulated Gate Bipolar Transistor), a power MOS (Metal Oxide Semiconductor) transistor, a power bipolar transistor, or the like can be employed as the power semiconductor switching element (hereinafter simply referred to as a “switching element”). Anti-parallel diodes D1, D2 are arranged for switching elements Q1, Q2, respectively. Reactor L1 is connected between a connection node of switching elements Q1 and Q2 and power line 6. In addition, smoothing capacitor C0 is connected between power line 7 and power line 5.

Smoothing capacitor C0 smoothes a DC voltage of power line 7. A voltage sensor 13 detects a voltage across opposing ends of smoothing capacitor C0, that is, a DC voltage VH on power line 7. DC voltage VH corresponding to a DC link voltage of inverter 14 will hereinafter also be referred to as a “system voltage VH.” On the other hand, a DC voltage VL of power line 6 is detected by a voltage sensor 19. DC voltages VH, VL detected by voltage sensors 13, 19, respectively, are input to control device 30.

Inverter 14 is constituted of upper and lower arms 15 of a U-phase, upper and lower arms 16 of a V-phase, and upper and lower arms 17 of a W-phase, provided in parallel between power line 7 and power line 5. The upper and lower arms of each phase are constituted of switching elements connected in series between power line 7 and power line 5. For example, upper and lower arms 15 of the U-phase are constituted of switching elements Q3, Q4, upper and lower arms 16 of the V-phase are constituted of switching elements Q5, Q6, and upper and lower arms 17 of the W-phase are constituted of switching elements Q7, Q8. In addition, anti-parallel diodes D3 to D8 are connected to switching elements Q3 to Q8, respectively. On and off of switching elements Q3 to Q8 is controlled by switching control signals S3 to S8 from control device 30, respectively.

Representatively, AC electric motor M1 is a three-phase permanent magnet type synchronous electric motor, and it is constituted such that one ends of three coils of the U-, V-, and W-phases are commonly connected to a neutral point. In addition, the other ends of the coils of respective phases are connected to intermediate points of switching elements of upper and lower arms 15 to 17 of respective phases.

Boost converter 12 is basically controlled such that switching elements Q1 and Q2 are complementarily and alternately turned on and off in each switching cycle corresponding to one cycle of a carrier wave used for PWM control. Boost converter 12 can control a boost ratio (VH/VL) by controlling a ratio between ON periods (a duty ratio) of switching elements Q1, Q2. Therefore, on and off of switching elements Q1, Q2 is controlled in accordance with a duty ratio operated in accordance with detection values of DC voltages VL, VH and a voltage command value VH#.

By complementarily turning on and off switching element Q1 and switching element Q2, charging and discharging of DC power supply B can both be addressed without changing control in accordance with a direction of a current through reactor L1. Namely, through control of system voltage VH in accordance with voltage command value VH#, boost converter 12 can address both of regeneration and power running.

It is noted that, while output from AC electric motor M1 is low, AC electric motor M1 can be controlled in a state of VH=VL (a boost ratio=1.0) without boost by boost converter 12. In this case (hereinafter also referred to as a “non-boost mode”), switching elements Q1 and Q2 are fixed to on and off, respectively, and hence electric power loss in boost converter 12 is lowered.

In a case where a torque command value of AC electric motor M1 is positive (Tqcom>0), when a DC voltage is supplied from smoothing capacitor C0, inverter 14 converts the DC voltage through a switching operation of switching elements Q3 to Q8 in response to switching control signals S3 to S8 from control device 30 and drives AC electric motor M1 so as to output positive torque. Alternatively, in a case where a torque command value of AC electric motor M1 is zero (Tqcom=0), inverter 14 converts a DC voltage to an AC voltage through a switching operation in response to switching control signals S3 to S8 and drives AC electric motor M1 such that torque attains to zero. Thus, AC electric motor M1 is driven to generate zero or positive torque designated by a torque command value Tqcom.

In addition, during regenerative braking of an electrically-powered vehicle incorporating control system 100, torque command value Tqcom of AC electric motor M1 is set to negative (Tqcom<0). In this case, inverter 14 converts an AC voltage generated by AC electric motor M1 to a DC voltage through a switching operation in response to switching control signals S3 to S8, and supplies the resultant DC voltage (system voltage VH) to boost converter 12 through smoothing capacitor C0.

It is noted that regenerative braking herein includes braking accompanying regeneration when a driver driving an electrically-powered vehicle operates a foot brake, and deceleration (or stop of acceleration) of a vehicle while carrying out regeneration, in which an accelerator pedal is off during running although a foot brake is not operated.

A current sensor 24 detects a current (a phase current) which flows through AC electric motor M1 and outputs the detection value to control device 30. It is noted that, since the sum of instantaneous values for three-phase currents iu, iv, iw is zero, the current sensors may be arranged to detect motor currents of two phases as shown in FIG. 1 (for example, a V-phase current iv and a W-phase current iw).

A rotation angle sensor (resolver) 25 detects an angle of rotation θ of a rotor of AC electric motor M1, and sends detected angle of rotation θ to control device 30. Control device 30 can calculate a rotation speed Nmt and a rotation angle velocity co of AC electric motor M1 based on angle of rotation θ. It is noted that rotation angle sensor 25 does not have to be arranged, by directly operating angle of rotation θ based on a motor voltage or a current in control device 30.

Control device 30 is configured with an electronic control unit (ECU) and it controls an operation of control system 100 through software processing in which a not-shown CPU (Central Processing Unit) executes a program stored in advance and/or through hardware processing using dedicated electronic circuitry.

As a representative function, control device 30 controls an operation of boost converter 12 and inverter 14 such that AC electric motor M1 outputs torque in accordance with torque command value Tqcom with a control scheme which will be described later, based on input torque command value Tqcom, DC voltage Vb detected by voltage sensor 10, DC current Ib detected by current sensor 11, system voltage VH detected by voltage sensor 13 and motor currents iv, iw detected by current sensor 24, angle of rotation θ from rotation angle sensor 25, and the like.

Namely, in order to control DC voltage VH in accordance with voltage command value VH# as above, control device 30 generates switching control signals S1, S2 for boost converter 12. In addition, control device 30 generates control signals S3 to S8 for controlling output torque from AC electric motor M1 in accordance with torque command value Tqcom. Control signals S1 to S8 are input to boost converter 12 and inverter 14.

Torque command value Tqcom is calculated in accordance with a map having an accelerator position, a vehicle speed, and the like as parameters.

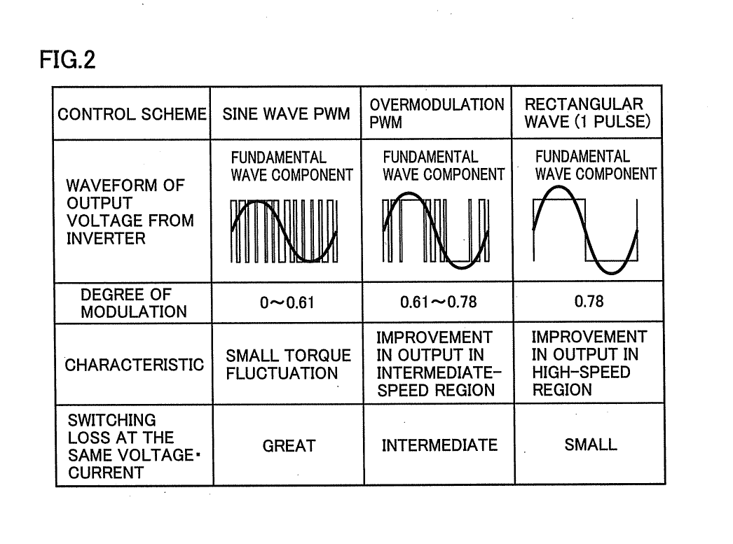

FIG. 2 is a diagram illustrating an inverter control scheme for controlling the AC electric motor. As shown in FIG. 2, in the control system for the AC electric motor according to the embodiment of the present invention, three control schemes are switched for use for control of an AC electric motor by inverter 14.

Sine wave PWM control is used as general PWM control, in which on and off of a switching element in the arm of each phase is controlled based on voltage comparison between a sinusoidal voltage command value and a carrier wave (representatively, a triangular wave). Consequently, regarding a set of a high-level period corresponding to an ON period of an element in the upper arm and a low-level period corresponding to an ON period of an element in the lower arm, a duty ratio is controlled such that a fundamental wave component thereof exhibits a sine wave within a certain period.

Hereinafter, a ratio of a voltage (an effective value of a line voltage) applied to AC electric motor M1 to system voltage VH in DC-AC voltage conversion by an inverter will herein be defined as a “degree of modulation.” Application of sine wave PWM control is basically limited to a state where AC voltage amplitude (a phase voltage) of each phase is equal to system voltage VH. Namely, in sine wave PWM control, a degree of modulation can be increased only up to 0.61.

On the other hand, in rectangular wave voltage control, an inverter outputs one pulse of a rectangular wave having a ratio between a high-level period and a low-level period of 1:1 within a period corresponding to 360 degrees of an electric angle of the electric motor. Thus, a degree of modulation is raised up to 0.78.

Overmodulation PWM control refers to control for carrying out PWM control the same as sine wave PWM control above for a voltage command value (sinusoidal) greater in amplitude than a carrier wave, with that amplitude being increased.

Consequently, by distorting a fundamental wave component, a degree of modulation can be raised to a range from 0.61 to 0.78.

In control system 100 for AC electric motor M1 according to the present embodiment, in accordance with a state of AC electric motor M1, sine wave PWM control, overmodulation PWM control, and rectangular wave voltage control described above are selectively applied.

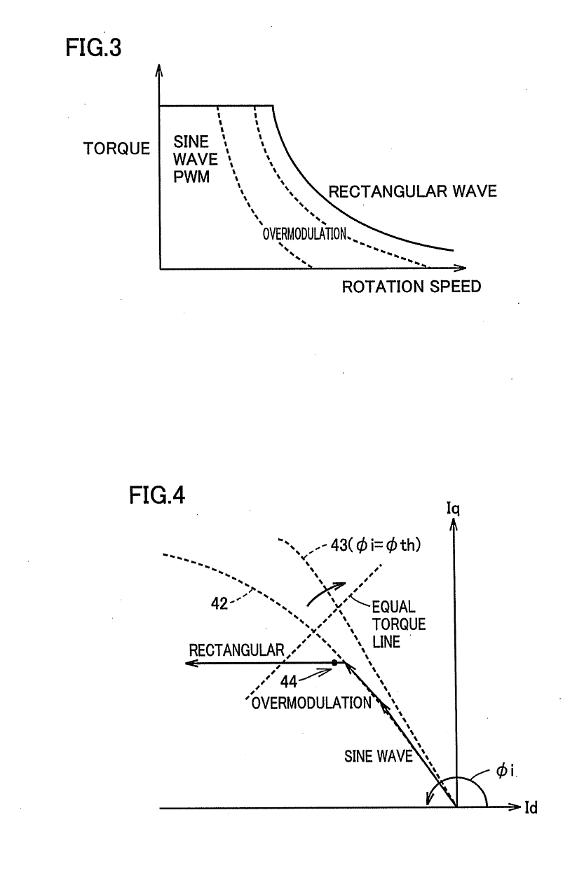

Generally, as shown in FIG. 3, sine wave PWM control is selected in a low-speed rotation region to an intermediate-speed rotation region, overmodulation control is selected in the intermediate-speed rotation region to a high-speed rotation region, and rectangular wave voltage control is selected in a higher-speed rotation region. A specific method for selecting a control scheme will be described later.

As shown in FIG. 4, in sine wave PWM control and overmodulation PWM control, motor current control by inverter 14 is carried out such that a current phase φi of AC electric motor M1 is located on an optimal current advance line 42. The abscissa in FIG. 4 represents a d-axis current Id and the ordinate in FIG. 4 represents a q-axis current Iq.

Optimal current advance line 42 is drawn as a set of current phase points at which loss in AC electric motor M1 on an equal torque line on an Id-Iq plane serves as a reference. Therefore, current command values Idcom, Iqcom on the d-axis and the q-axis are generated to correspond to a point of intersection between the equal torque line corresponding to torque command value Tqcom for AC electric motor M1 which is determined in accordance with the map having an accelerator position, a vehicle speed, and the like as parameters, and optimal current advance line 42. Optimal current advance line 42 can be found through experiments or simulation in advance.

Therefore, a map determining combination of current command values Idcom, Iqcom on optimal current advance line 42 in correspondence with each torque command value can be created in advance and stored in control device 30.

FIG. 4 shows with an arrow, a trace along which a position of a tip end of a current vector (a current phase) resulting from combination of Id, Iq having a zero point position as an origin varies with increase in output torque. With increase in output torque, magnitude of a current (corresponding to magnitude of a current vector on the Id-Iq plane) increases. As described above, in sine wave PWM control and overmodulation PWM control, a current phase is controlled to be located on optimal current advance line 42 by setting of current command values Idcom, Iqcom.

In rectangular wave voltage control, inverter 14 cannot directly control a current phase of AC electric motor M1. Since field-weakening control is carried out in rectangular wave voltage control, output torque increases as a voltage phase φv is made greater. Accordingly, an absolute value of d-axis current Id which is a field current increases. Consequently, a position of the tip end of the current vector (the current phase) is away from optimal current advance line 42 to the left in the figure (toward an advance side). Since the current vector is not located on optimal current advance line 42, loss in AC electric motor M1 increases in rectangular wave voltage control.

In contrast, transition from rectangular wave voltage control to PWM control is indicated when current phase φi is smaller than prescribed φth (a reference value) during rectangular wave voltage control.

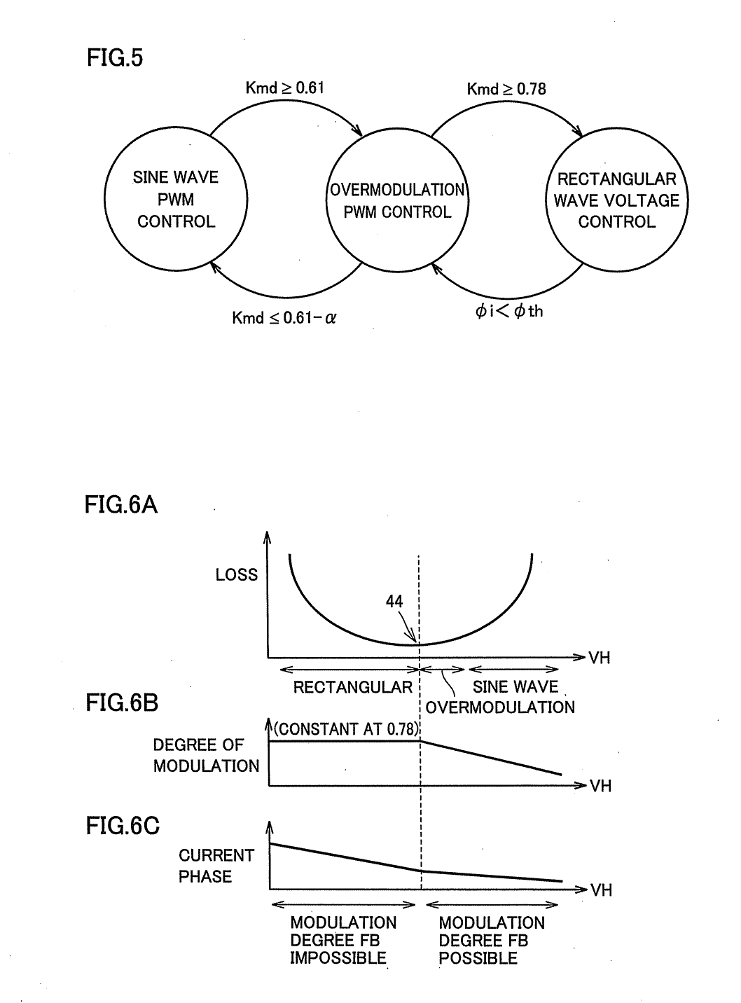

Mode switching among sine wave PWM control, overmodulation PWM control, and rectangular wave voltage control will be described with reference to FIG. 5.

During application of sine wave PWM or overmodulation PWM control, a degree of modulation Kmd is calculated from voltage command values Vd#, Vq# on the d-axis and the q-axis which will be described later and system voltage VH, with the following equation 1.

Kmd=(Vd#²+Vq#2)^{1/2}/VH (1)

When a degree of modulation of inverter 14 exceeds 0.61 while sine wave PWM control is carried out, a control mode is switched from sine wave PWM control to overmodulation PWM control. When a degree of modulation of inverter 14 is lower than a prescribed threshold value SH (SH=0.61−α) which is smaller than 0.61 while overmodulation PWM control is carried out, the control mode is switched from overmodulation PWM control to sine wave PWM control.

When a degree of modulation of inverter 14 further increases and exceeds 0.78 while overmodulation PWM control is carried out, the control mode is switched from overmodulation PWM control to rectangular wave voltage control.

On the other hand, when current phase φi is smaller than reference value φth with decrease in output torque during rectangular wave voltage control, transition to an overmodulation PWM control mode is indicated.

Energy loss in sine wave PWM control, overmodulation PWM control, and rectangular wave voltage control can vary in accordance with system voltage VH, as shown in FIG. 6A. FIGS. 6A to 6C show a behavior of the control system under such a condition that output (a product of a rotation speed and torque) from AC electric motor M1 is constant and only system voltage VH is varied.

FIG. 6A shows relation between system voltage VH and total loss in the control system throughout three control modes. FIG. 6B shows relation between system voltage VH and degree of modulation Kmd. FIG. 6C shows relation between system voltage VH and a motor current phase.

Referring to FIGS. 6A to 6C, in a region where sine wave PWM control and overmodulation PWM control are applied, loss decreases as system voltage VH is lower and a degree of modulation is raised. Then, since loss in boost converter 12 and inverter 14 is minimized at an operation point 44 at which rectangular wave voltage control is applied, loss in the overall system is also minimized.

Since a degree of modulation is fixed at 0.78 in a region in which rectangular wave voltage control is applied, voltage phase φv for obtaining the same output is greater as system voltage VH is lowered. Accordingly, as described previously, with increase in field-weakening current, the current phase is away from optimal current advance line 42. Therefore, system loss increases due to increase in loss in AC electric motor M1. Namely, in rectangular wave voltage control, as system voltage VH lowers, total loss in the system will increase.

In contrast, when PWM control is applied by raising system voltage VH, the current phase of AC electric motor M1 can be controlled along optimal current advance line 42. When AC electric motor M1 is operated under PWM control, however, loss in AC electric motor M1 can be lowered while loss in inverter 14 increases due to increase in the number of times of switching.

Therefore, it is when rectangular wave voltage control is applied and a current phase of AC electric motor M1 is in the vicinity of optimal current advance line 42 that loss in the overall control system including AC electric motor M1 is minimized. Namely, system voltage VH is preferably set such that such a state is established.

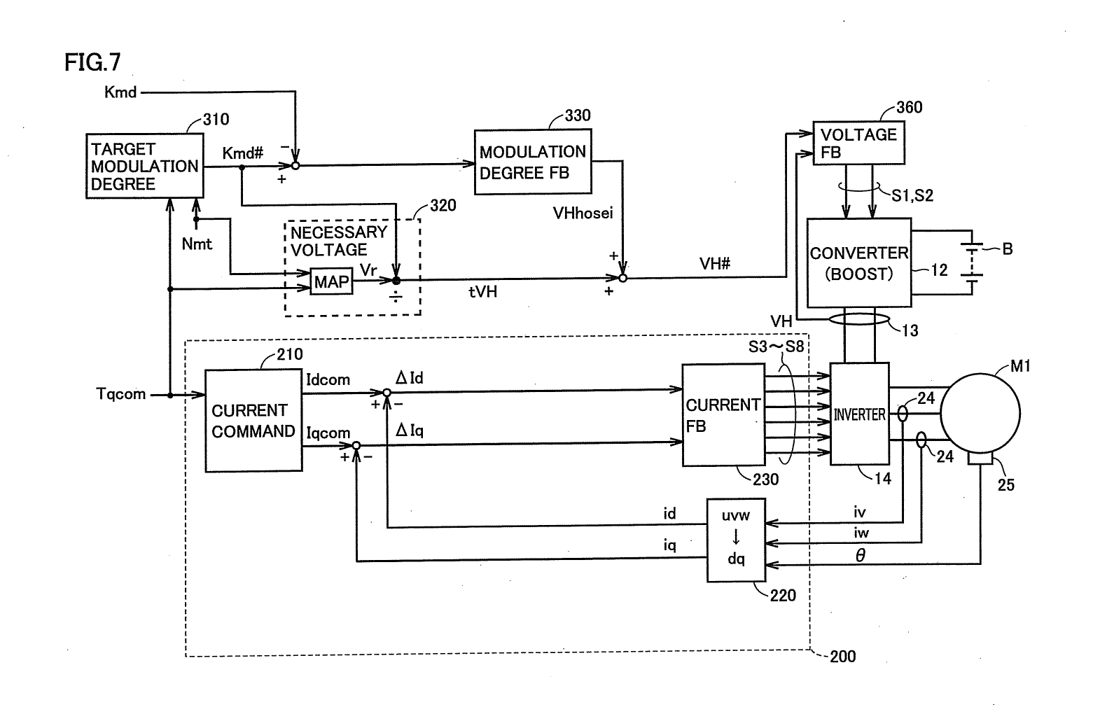

Specific processing in sine wave PWM control and overmodulation PWM control will be described with reference to FIG. 7. FIG. 7 is a functional block diagram illustrating a control configuration in PWM control in the control system for the AC electric motor according to the embodiment of the present invention. Each functional block shown in block diagrams described below and represented by FIG. 7 is implemented by hardware or software processing by control device 30.

Referring to FIG. 7, a PWM control unit 200 includes a current command generation portion 210, a conversion portion 220, and a current feedback portion 230.

Current command generation portion 210 generates a d-axis current command value Idcom and a q-axis current command value Iqcom in accordance with torque command value Tqcom for AC electric motor M1, in accordance with the map created in advance or the like.

Conversion portion 220 converts three-phase motor currents iu, iv, iw which flow in AC electric motor M1 to two-phase currents id, iq on the d-axis and the q-axis through coordinate conversion using a rotor rotation angle θ, and outputs the same. Specifically, a U-phase current iu (iu=−iv−iw) is calculated from a V-phase current iv and a W-phase current iw detected by current sensor 24. Actual d-axis current id and q-axis current iq are calculated based on these currents iu, iv, iw, in accordance with angle of rotation θ detected by rotation angle sensor 25.

Current feedback portion 230 receives input of a difference ΔId (ΔId=Idcom−id) between d-axis current command value Idcom and calculated actual d-axis current id and a difference ΔIq (ΔIq=Iqcom−iq) between q-axis current command value Iqcom and calculated actual q-axis current iq. Current feedback portion 230 performs PI (proportional integration) operation with prescribed gain for each of d-axis current difference ΔId and q-axis current difference ΔIq to thereby find control deviation, and generates d-axis voltage command value Vd# and q-axis voltage command value Vq# in accordance with this control deviation. In addition, current feedback portion 230 converts d-axis voltage command value Vd# and q-axis voltage command value Vq# to voltage commands of respective phases Vu, Vv, Vw of the U-phase, the V-phase, the W-phase, through coordinate conversion (two phases three phases) using angle of rotation θ of AC electric motor M1 and generates switching control signals S3 to S8 in accordance with voltage command values of respective phases Vu, Vv, Vw. A pseudo sine wave voltage is generated in each phase of AC electric motor M1, through a switching operation by inverter 14 in response to switching control signals S3 to S8.

Control device 30 for the motor drive system according to the embodiment of the present invention further includes a target modulation degree calculation portion 310, a necessary voltage calculation portion 320, a modulation degree feedback portion 330, and a voltage feedback portion 360.

Target modulation degree calculation portion 310, necessary voltage calculation portion 320, and modulation degree feedback portion 330 are functional blocks for calculating a requested voltage VHreq as an output voltage from boost converter 12 for maintaining degree of modulation Kmd of inverter 14 at a target degree of modulation Kmd#.

More specifically, target modulation degree calculation portion 310 sets target degree of modulation Kmd# for each combination of a target control mode selected in accordance with an accelerator position (hereinafter also denoted as a requested control mode) and a current control mode CntMode. A method of setting target degree of modulation Kmd# will be described later in detail.

Necessary voltage calculation portion 320 calculates a necessary voltage tVH as an output voltage from boost converter 12 necessary for realizing target torque (torque command value Tqcom) from target torque (torque command value Tqcom). By way of example, necessary voltage calculation portion 320 calculates necessary voltage tVH in accordance with a map having target degree of modulation Kmd# calculated by target modulation degree calculation portion 310, target torque (torque command value Tqcom), and rotation speed Nmt of AC electric motor M1 as parameters. More specifically, by way of example, necessary voltage tVH is calculated by dividing a voltage Vr found from torque command value Tqcom and rotation speed Nmt by referring to the map by target degree of modulation Kmd#. Voltage Vr is a voltage applied to AC electric motor M1 (an effective value of a line voltage).

Modulation degree feedback portion 330 finds a target system voltage by calculating a ratio of actual degree of modulation Kmd to target degree of modulation Kmd# (Kmd/Kmd#) and multiplying this ratio by current system voltage VH. In addition, a value ΔVH obtained by subtracting current system voltage VH from this target system voltage and an integration value Δ∫VH thereof are calculated. A proportional term KpΔVH and an integral term Ki∫ΔVH are calculated by multiplying value ΔVH and integration value ∫ΔVH by proportional gain Kp and integration gain Ki. Modulation degree feedback portion 330 calculates the sum of these proportional term KpΔVH and integral term Ki∫ΔVH as a correction voltage VHhosei.

The sum of necessary voltage tVH and correction voltage VHhosei is input as voltage command value VH# to voltage feedback portion 360. Voltage feedback portion 360 generates switching control signals S1, S2 such that an output voltage from boost converter 12 attains to voltage command value VH#, based on voltage command value VH# and current system voltage VH.

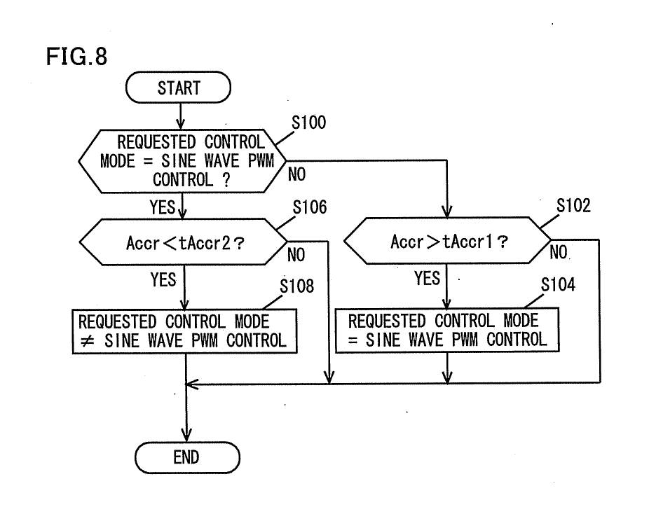

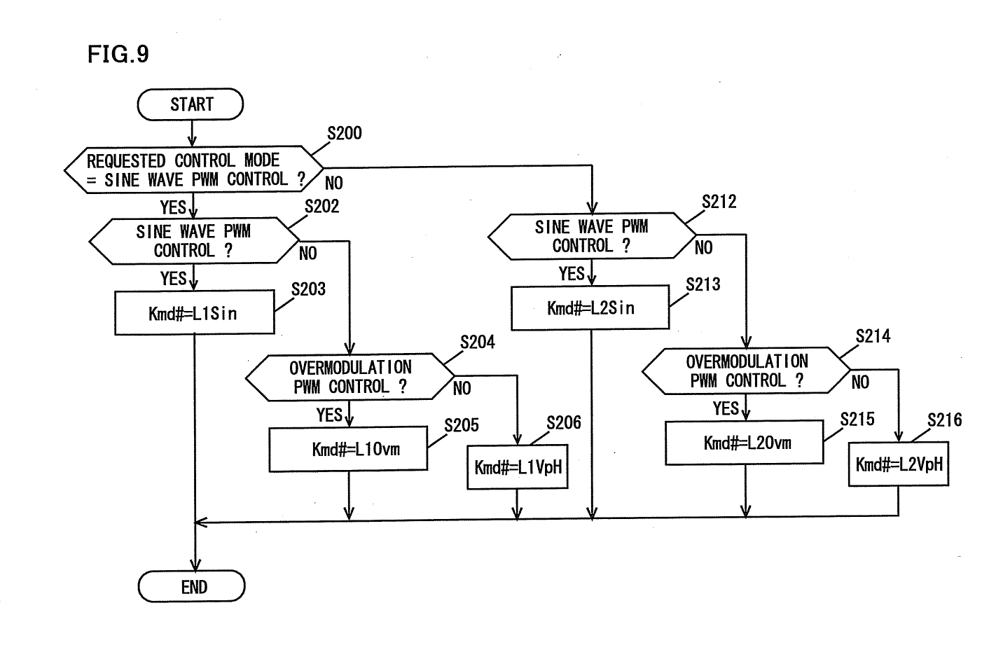

Processing performed in target modulation degree calculation portion 310 for setting a requested control mode and target degree of modulation Kmd# will be described with reference to FIGS. 8 and 9. Referring to FIG. 8, in step (hereinafter a step being abbreviated as S) 100, whether or not the currently requested control mode is sine wave PWM control is determined. When the current control mode is not sine wave PWM control (NO in S100) and when an accelerator position Accr is greater than a prescribed threshold value tAccr1 (YES in S102), the requested control mode is set to sine wave PWM control in S104. It is noted that accelerator position Accr is detected by an accelerator position sensor as is well known.

When the current control mode is sine wave PWM control (YES in S100) and when accelerator position Accr is smaller than a prescribed threshold value tAccr2 (tAccr2<tAccr1) (YES in S106), the requested control mode is no longer sine wave PWM control in S108.

Referring to FIG. 9, when the currently requested control mode is sine wave PWM control (YES in S200) and when the current control mode is sine wave PWM control (YES in S202), in S203, a prescribed value L1Sin predetermined by a developer within a range from 0 to 0.61 is set as target degree of modulation Kmd#.

When the currently requested control mode is sine wave PWM control (YES in S200) and when the current control mode is overmodulation PWM control (NO in 5202, YES in S204), in S205, a prescribed value L1Ovm predetermined by the developer such that it is smaller than threshold value SH (SH=0.61−α) at the time when the control mode switches from overmodulation PWM control to sine wave PWM control is set as target degree of modulation Kmd#. As described above, since an output voltage from converter 12 is controlled such that degree of modulation Kmd of inverter 14 matches with target degree of modulation Kmd#, the output voltage from converter 12 is consequently increased until the control mode switches from overmodulation PWM control to sine wave PWM control.

When the currently requested control mode is sine wave PWM control (YES in S200) and when the current control mode is rectangular wave voltage control (NO in S202 and NO in S204), in S206, a prescribed value L1VpH predetermined by the developer is set as target degree of modulation Kmd#.

When the currently requested control mode is not sine wave PWM control (NO in S200) and when the current control mode is sine wave PWM control (YES in S212), in S213, a prescribed value L2Sin greater than 0.78 is set as target degree of modulation Kmd#.

When the currently requested control mode is not sine wave PWM control (NO in S200) and when the current control mode is overmodulation PWM control (NO in S212, and YES in S214), in S215, a prescribed value L2Ovm greater than 0.78 is set as target degree of modulation Kmd#. Prescribed value L2Ovm may be greater or smaller than, or equal to, prescribed value L2Sin.

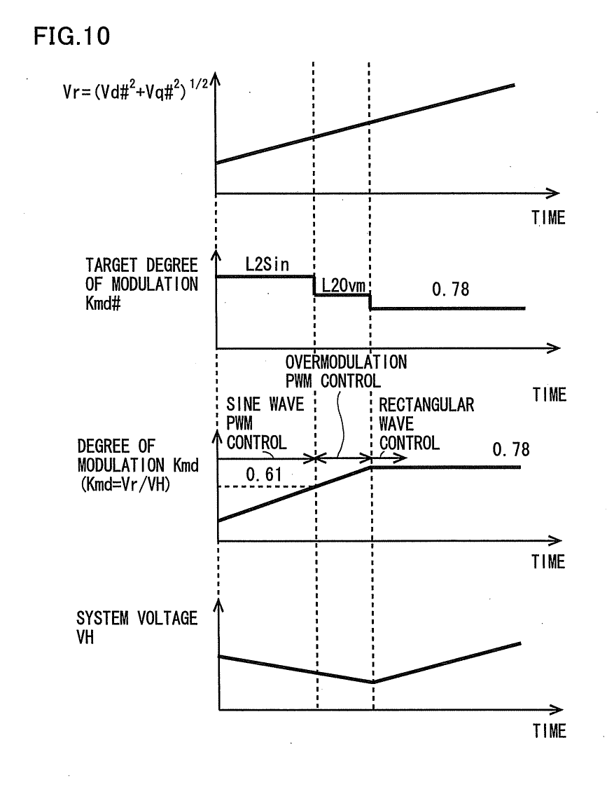

As described above, since the control mode is switched from PWM control to rectangular wave control when actual degree of modulation Kmd of inverter 14 is equal to or greater than 0.78, an output voltage from converter 12 is quickly lowered until the control mode is switched from PWM control to rectangular wave control as shown in FIG. 10 as prescribed value L2Ovm greater than 0.78 is set as target degree of modulation Kmd#.

When the currently requested control mode is not sine wave PWM control (NO in S200) and when the current control mode is rectangular wave voltage control (NO in S212 and NO in S214), in S216, a prescribed value L2VpH predetermined by the developer is set as target degree of modulation Kmd#.

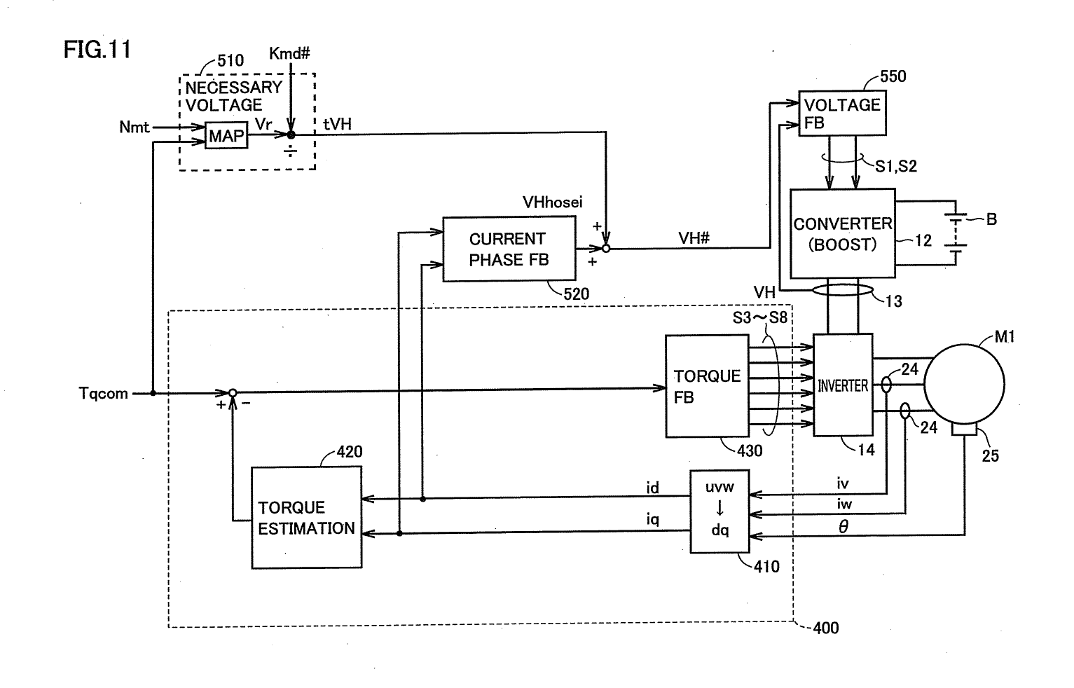

A control block diagram during the rectangular wave control scheme will be described hereinafter with reference to FIG. 11. It is noted that a degree of modulation is fixed during the rectangular wave control scheme as described above and hence feedback control of a degree of modulation as included in PWM control is not implemented.

Referring to FIG. 11, a rectangular wave control block 400 includes a conversion portion 410, a torque estimation portion 420, and a torque feedback portion 430.

Conversion portion 410 converts three-phase motor currents iu, iv, iw which flow in AC electric motor M1 to two-phase currents id, iq on the d-axis and the q-axis through coordinate conversion using rotor rotation angle θ, and outputs the same. Specifically, U-phase current iu (iu=−iv−iw) is calculated from V-phase current iv and W-phase current iw detected by current sensor 24. D-axis current id and q-axis current iq are generated based on these currents iu, iv, iw, in accordance with angle of rotation θ detected by rotation angle sensor 25.

Torque estimation portion 420 estimates actual torque Tq of AC electric motor M1 from d-axis current id and q-axis current iq in accordance with the map defining relation between torque and a current determined in advance.

Torque feedback portion 430 receives input of torque deviation ΔTq (ΔTq=Tqcom−Tq) from torque command value Tqcom. Torque feedback portion 430 performs PI operation with prescribed gain for torque deviation ΔTq to thereby find control deviation, and sets a phase φv of a rectangular wave voltage in accordance with the found control deviation. Specifically, during generation of positive torque (Tqcom>0), a voltage phase is advanced when torque is insufficient, whereas a voltage phase is retarded when torque is excessive. During generation of negative torque (Tqcom<0), a voltage phase is retarded when torque is insufficient, whereas a voltage phase is advanced when torque is excessive.

In addition, torque feedback portion 430 generates voltage command values (rectangular wave pulses) of respective phases Vu, Vv, Vw in accordance with set voltage phase φv, and generates switching control signals S3 to S8 in accordance with voltage command values of respective phases Vu, Vv, Vw. As inverter 14 performs a switching operation in accordance with switching control signals S3 to S8, a rectangular wave pulse in accordance with voltage phase φv is applied as a voltage of each phase of the motor.

Thus, during the rectangular wave control scheme, motor torque control can be carried out with feedback control of torque (electric power).

Control device 30 for the motor drive system according to the embodiment of the present invention further includes a necessary voltage calculation portion 510 and a current phase feedback portion 520.

Necessary voltage calculation portion 510 calculates necessary voltage tVH as an output voltage from boost converter 12 necessary for realizing target torque (torque command value Tqcom) from target torque (torque command value Tqcom). By way of example, necessary voltage calculation portion 510 calculates necessary voltage tVH in accordance with the map having prescribed target degree of modulation Kmd#, target torque (torque command value Tqcom), and rotation speed Nmt of AC electric motor M1 as parameters. More specifically, by way of example, necessary voltage tVH is calculated by dividing voltage Vr found from torque command value Tqcom and rotation speed Nmt by referring to the map by target degree of modulation Kmd#. Voltage Vr is a voltage applied to AC electric motor M1 (an effective value of a line voltage).

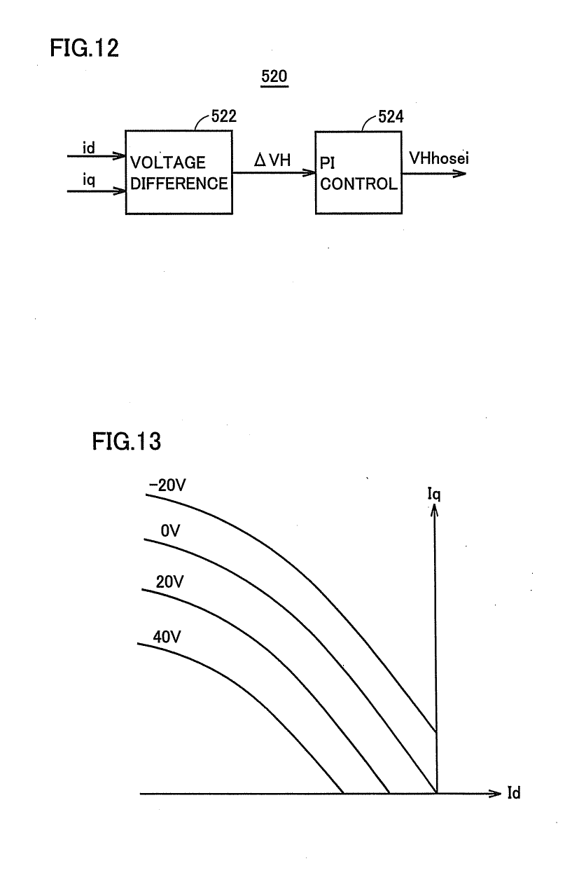

Current phase feedback portion 520 calculates correction value VHhosei for system voltage VH in accordance with d-axis current id and q-axis current iq generated by conversion portion 410. Current phase feedback portion 520 includes a voltage difference calculation portion 522 and a PI control unit 524 as shown in FIG. 12. Voltage difference calculation portion 522 calculates a voltage difference ΔVH in accordance with a map having d-axis current id and q-axis current iq as parameters, as shown in FIG. 13.

Referring back to FIG. 12, PI control unit 524 calculates proportional term KpΔVH and integral term Ki∫ΔVH by multiplying voltage difference ΔVH and integration value thereof ∫ΔVH by proportional gain Kp and integration gain Ki, respectively. PI control unit 524 calculates the sum of these proportional term KpΔVH and integral term Ki∫ΔVH as correction voltage VHhosei.

Referring back to FIG. 11, the sum of necessary voltage tVH and correction voltage VHhosei is input as voltage command value VH# to a voltage feedback portion 550. Voltage feedback portion 550 generates switching control signals S1, S2 such that an output voltage from boost converter 12 attains to a voltage command value VHcom, based on voltage command value VH# and current system voltage VH.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A vehicle comprising:
a converter converting and outputting a voltage;
an inverter converting DC power output from said converter to AC power;
a motor driven by AC power supplied from said inverter; and
a control device configured to control said converter and said inverter,
said control device
controlling said inverter in a control mode selected in accordance with a degree of modulation of said inverter and selecting a target control mode of said inverter, and
varying an output voltage from said converter such that a degree of modulation of said inverter varies until said control mode switches to said target control mode when a current control mode according to said degree of modulation is different from said target control mode.

2. The vehicle according to claim 1, wherein
said control device
switches the control mode when the degree of modulation of said inverter exceeds a prescribed threshold value,
sets a value greater than said threshold value as a target degree of modulation when the current control mode is different from said target control mode, and
lowers the output voltage from said converter such that the degree of modulation of said inverter varies to said target degree of modulation.

3. The vehicle according to claim 1, wherein
said control device
switches the control mode when the degree of modulation of said inverter is lower than a prescribed threshold value,
sets a value smaller than said threshold value as a target degree of modulation when the current control mode is different from said target control mode, and
raises the output voltage from said converter such that the degree of modulation of said inverter varies to said target degree of modulation.

4. The vehicle according to claim 1, wherein
said control device selects said target control mode of said inverter in response to an operation of an accelerator by a driver.

5. The vehicle according to claim 2, wherein
said control device selects said target control mode of said inverter in response to an operation of an accelerator by a driver.

6. The vehicle according to claim 3, wherein
said control device selects said target control mode of said inverter in response to an operation of an accelerator by a driver.

7. A control device for a vehicle incorporating a converter converting and outputting a voltage, an inverter converting DC power output from said converter to AC power, and a motor driven by AC power supplied from said inverter, comprising:
inverter control means for controlling said inverter in a control mode selected in accordance with a degree of modulation of said inverter;
selection means for selecting a target control mode of said inverter; and
converter control means for varying an output voltage from said converter such that a degree of modulation of said inverter varies until said control mode switches to said target control mode when a current control mode according to said degree of modulation is different from said target control mode.

8. The control device for a vehicle according to claim 7, wherein
said inverter control means switches the control mode when the degree of modulation of said inverter exceeds a prescribed threshold value, and
said converter control means includes
means for setting a value greater than said threshold value as a target degree of modulation when the current control mode is different from said target control mode, and
means for lowering the output voltage from said converter such that the degree of modulation of said inverter varies to said target degree of modulation.

9. The control device for a vehicle according to claim 7, wherein
said inverter control means switches the control mode when the degree of modulation of said inverter is lower than a prescribed threshold value, and
said converter control means includes
means for setting a value smaller than said threshold value as a target degree of modulation when the current control mode is different from said target control mode, and
means for raising the output voltage from said converter such that the degree of modulation of said inverter varies to said target degree of modulation.

10. The control device for a vehicle according to claim 7, wherein
said selection means selects the target control mode of said inverter in response to an operation of an accelerator by a driver.

11. The control device for a vehicle according to claim 8, wherein
said selection means selects the target control mode of said inverter in response to an operation of an accelerator by a driver.

12. The control device for a vehicle according to claim 9, wherein
said selection means selects the target control mode of said inverter in response to an operation of an accelerator by a driver.
